(19) United States
(12) Patent Application Publication
(10) Pub. No.: US 2004/0037287 A1
(43) Pub. Date: Feb. 26, 2004

(54) Method for measuring the number of service packets of mobile handset

(75) Inventor: Young-Jo Jeong, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/449,884

(22) Filed: Jun. 2, 2003

(30) Foreign Application Priority Data
Jun. 3, 2002 (KR) 31150/2002

(51) Int. Cl. H04Q 7/00

(52) U.S. Cl. 370/394; 370/328

(57) ABSTRACT

Disclosed is a method for measuring the number of service packets transmitted and/or received by a mobile handset, in which information for data service amount is provided to a data service user through the mobile handset. As a result, the user can estimate charges for mobile communication data services as they are accrued, thus allowing the user to manage cost and use the mobile data service capability more efficiently.

### BACKGROUND OF THE INVENTION

1. Field of the Invention

The present invention relates to a communication service, and more particularly, to a data communication service.

2. Background of the Related Art

Whereas first and second generation mobile communication is limited to audio service, third generation mobile communication provides not only audio service but also various other services, such as data service and multi media service. Accordingly, telecommunication service providers must adjust their usage monitoring and related charging systems to adapt to this changing service environment.

In this new environment, charges for audio service are based on service usage time, and charges for data service are based on amount of service data (hereinafter, the amount of data service will be referred to as the number of packets).

FIG. 1 is a schematic view showing a related art procedure for providing mobile communication service. In order to use data service such as internet service, a mobile user preferably accesses a system which provides mobile communication service (hereinafter, mobile communication service will be referred to as service) and requests the necessary data. To this end, a mobile handset 10 sets a channel with a packet data serving node (PDSN) or an inter-working function (IWF) 20.

When a communication channel is set between the mobile handset 10 and the PDSN (or IWF) 20 by point-to-point Protocol (PPP), the mobile handset 10 accesses a server via a set channel and demands the necessary data transmission from the server. The server then transmits the required data to the corresponding mobile handset 10, the mobile handset 10 receives the data, and the communication channel is released.

In the case of audio service, a communication operator measures the elapsed time from when the communication channel is set between the mobile handset 10 and the PDSN 20 to when the communication channel is released. This interval is referred to as the communication channel occupation time. The communication operator then calculates a charge amount based on the communication channel occupation time. However, in the case of data service, the communication operator calculates the number of packets exchanged in the communication channel occupation time, and calculates a charge amount based on the number of packets.

In the related art, the mobile handset provides the user with information on service usage time but does not provide information on the amount of data service, so the user cannot estimate data set-vice charges and cannot manage the data service efficiently.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

An object of the present invention is to measure the number of service packets exchanged, e.g., transmitted and/or received.

Another object of the present invention is to provide information related to data service to a user.

To achieve these and other advantages and in accordance with the purpose of the present invention, as embodied and broadly described herein, there is provided a method for measuring the number of service packets exchanged by a mobile handset comprising: setting a communication network and a channel, accessing a server, and thus transmitting or receiving data; extracting a predetermined payload from the transmitted or received data; storing a size of the extracted payload and converting into the number of packets; and displaying the number of the transmitted or received packets when the channel setting is released.

Preferably, the step for extracting payload is performed in a TCP layer or a UDP layer.

Preferably, the method for measuring the number of service packets of a mobile handset further comprises: setting a state value of a packet amount measuring flag to ‘enable’ when the communication channel is set; and setting the state value of a packet amount measuring flag to ‘disable’ when the communication channel is released.

To achieve these and other advantages and in accordance with the purpose of the present invention, as embodied and broadly described herein, there is provided a method for measuring the number of service packets exchanged by a mobile handset comprising: setting a communication network and a channel, accessing a server, and thus transmitting or receiving data; extracting a predetermined payload from the transmitted or received data; storing a size of the extracted payload and converting into the number of packets; outputting the number of the packets to a display unit; and performing the processes of extracting, storing, and outputting until the channel setting is released.

Preferably, in the step of converting into the number of the packets, the size of the extracted payload is divided by the number of bytes corresponding to one packet thus to obtain a quotient.

Preferably, the payload size is a byte unit.

The present invention can be achieved in a whole or parts by a method for measuring a number of service packets transmitted and/or received by a mobile communication device including, setting a communication network, setting a channel, accessing a server, and transmitting data and/or receiving data, extracting a predetermined payload from the transmitted and/or received data, storing a size of the extracted payload, converting the size of the extracted payload into a number of packets transmitted and/or received, releasing the channel setting, and displaying the number of packets transmitted and/or received.

The present invention can be further achieved in a whole or parts by a method for measuring a number of service packets transmitted and/or received by a mobile communication device including, setting a communication network; setting a channel, accessing a server, and transmitting data and/or receiving data, extracting a predetermined payload from the transmitted and/or received data, storing a size of the extracted payload, converting the size of the extracted payload into a number of packets transmitted and/or received, outputting the number of packets transmitted and/or received to a display unit, and performing the processes of extracting, storing, converting, and outputting until the channel setting is released.

The present invention can be further achieved in a whole or parts by a method for providing information regarding a number of packets exchanged by a communication device, including, exchanging data, extracting a predetermined payload from the exchanged data, calculating a number of packets exchanged from the predetermined payload, and providing information regarding the number of packets exchanged by the communication device via an output device of the communication device.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic view showing a related art procedure for providing mobile communication;

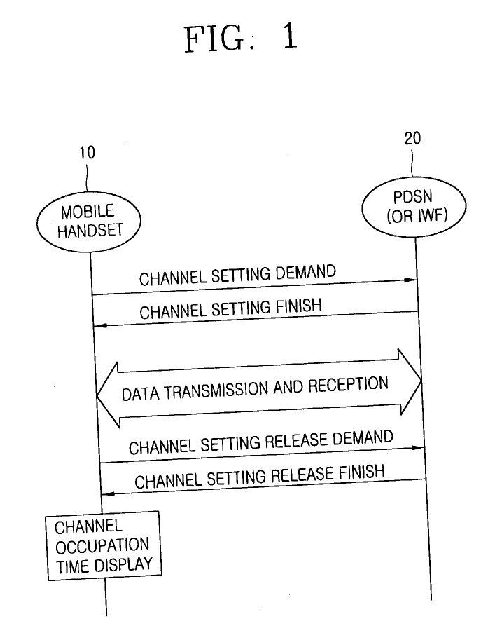

FIG. 2 is a flow chart of a method for measuring the number of packets according to an embodiment of the present invention; and

FIG. 3 is a flow chart of a method for measuring the number of packets according to another embodiment of the present invention.

### DETAILED DESCRIPTION OF PREFERRED EMBODIMENTS

The present invention comprises a method whereby an amount of data service usage accrued by a user is provided to the user through a mobile handset at the time the data communication service is used, in which the mobile handset measures amount of data service by a packet unit and provides that information to the user.

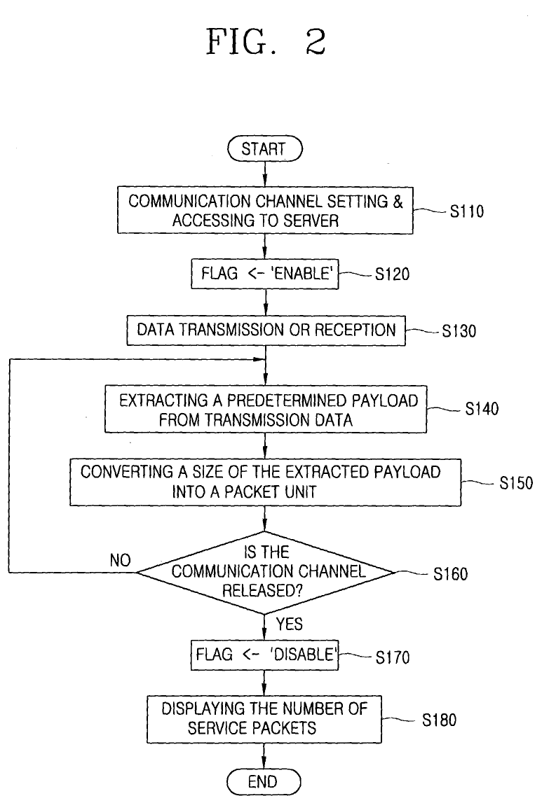

As shown in FIG. 2, the method for measuring the number of packets transmitted and/or received by a mobile handset according to an embodiment of the present invention comprises: setting a communication network and a channel, and accessing to a server (S110); transmitting data to the server or receiving data from the server (S130); extracting a predetermined payload from the transmitted or received data (S140); storing a size of the extracted payload and converting the size of the extracted payload into a number of packets (S150); and displaying the number of transmitted and/or received packets when the channel setting is released (S180).

The method for measuring the number of packets further comprises: setting a state value of a packet amount measuring flag to ‘enable’ when the communication channel is set (S120); and setting the state value of a packet amount measuring flag to ‘disable’ when the communication channel is released (S170).

In order to access the server, a mobile handset 10 requires that a PPP communication channel be set with a packet data serving node (PDSN) or an inter-working function (IWF) 20. When a communication channel is set between the mobile handset 10 and the PDSN (or IWF) 20, the mobile handset 10 accesses the server (S110). Then, the mobile handset 10 sets an ‘enable’ state value in a flag for calculating the number of packets (S120).

While setting the state value of the flag to ‘enable’ (S120), the mobile handset 10 starts to transmit or receive data (S130). The mobile handset extracts a predetermined payload from the transmitted and/or received data, and records a size of the extracted payload (in byte units) in a predetermined storage area (S140).

Processing routines for extracting the payload are different, depending on whether data is being uploaded or downloaded. When data are uploaded, the mobile handset 10 extracts a payload from the transmission control protocol (TCP) layer (or the user datagram protocol (UDP) layer), and when data are downloaded, the mobile handset 10 extracts a payload from the TCP layer (or the UDP layer) where each kind of header (PPP layer header, internet protocol (IP) layer header, TCP layer header, and the like) is removed.

The extracted payload data provided is substantially real time to the user with the transmitted and/or received data, and processed in an internal application of the mobile handset 10. In this case, the internal application refers to any applications which use a browser and each kind of packet bearer mounted in the mobile handset.

The size of the extracted payload is recorded in the storage area, and the mobile handset 10 converts the recorded size of the extracted payload into a number of packets (S150). For the conversion, a size of the packet is defined by the mobile communication service provider in advance. The number of bytes corresponding to one packet can be different based on the needs of individual service providers. For example, if one packet is defined as 512 bytes, cumulative data in the storage area is divided by 512 to obtain the number of service packets.

Once the number of packets is calculated, the mobile handset 10 checks a state of the communication channel (S160). If it is determined that the communication channel has been released, a state value of the flag is set to ‘disable’ (S170). However, if it is determined that the communication channel setting is active, the mobile handset 10 repeatedly performs the above processes S130˜S150 until it determines that the communication channel has been released and the state value of the flag has changed to ‘disable.’ When the state value of the flag is changed from ‘enable’ to ‘disable,’ the mobile handset 10 outputs information on the cumulative number of packets transmitted and/or received to a display unit of the mobile handset 10 (S180).

As can be appreciated by one of ordinary skill, an amount of data uploaded, an amount of data downloaded, and an amount of data uploaded and downloaded can be provided to the user. Further, a charge amount commensurate with the amount of data uploaded and/or downloaded can be automatically provided if the service has been appropriately programmed by the service provider, or provided manually if the user preprograms the handset to do so.

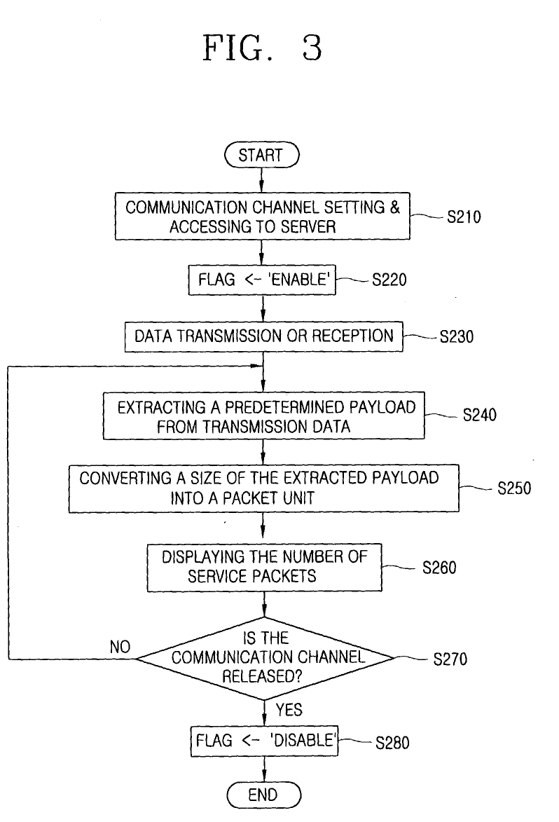

As shown in FIG. 3, the method for measuring the number of packets according to another embodiment of the present invention comprises: setting a communication network and a channel, and accessing a server (S210); transmitting data to the server or receiving data from the server (S230); extracting a predetermined payload from the transmitted or received data (S240); storing a size of the extracted payload and converting the size of the extracted payload into a number of packets (S250); outputting the number of the packets to a display unit (S260); and performing the processes of extracting, storing, and outputting until the channel setting is released.

The method for measuring the number of packets further comprises: setting a state value of a packet amount measuring flag to ‘enable’ when the communication channel is set (S220); and setting the state value of a packet amount measuring flag to ‘disable’ when the communication channel is released (S280).

First, a communication channel is set between the mobile handset 10 and the PDSN (or IWF) 20, and the mobile handset 10 accesses the server (S210). Then, the mobile handset 10 sets a state value of a flag to ‘enable’ (S220). While setting the state of the flag to ‘enable’, the mobile handset 10 starts to transmit or receive data (S230). The mobile handset extracts a predetermined payload from the transmitted or received data, and records a size of the extracted payload (a byte unit) in a predetermined storage area (S240). Then, the mobile handset 10 converts the recorded size of the payload into a number of packets (S250). The processes S210˜S250 are similar to steps S110-S150 shown in FIG. 2.

When the number of packets has been calculated, the mobile handset 10 outputs the number of packets to the display unit (S260) and checks a state of the communication channel (S270). At this time, if it is determined that the communication channel setting is active, the mobile handset 10 repeatedly performs the above processes S230˜S260. However, if it is determined that the communication channel has been released, a state value of the flag is set to ‘disable’ (S280).

According to this embodiment, the number of service packets is continuously displayed on the display unit while the user is using the mobile data communication service. With the number of service packets continuously displayed on the display unit of the mobile handset 10, the user can estimate the associated data service charges accrued whenever necessary.

The method for measuring a number of data service packets and providing that information to a user according to the present invention can be applied not only to a mobile communication handset but also to dial up networking access using a personal digital assistant (PDA) or a personal computer (PC).

As aforementioned, in the present invention, information for data service amount is provided to the data service user through the mobile handset. As a result, the user can estimate accrued charges based on the data service amount information, and thus can manage cost and use the data service more efficiently.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for measuring a number of service packets transmitted and/or received by a mobile communication device, comprising:
setting a communication network, setting a channel, accessing a server, and transmitting data and/or receiving data;
extracting a predetermined payload from the transmitted and/or received data;
storing a size of the extracted payload;
converting the size of the extracted payload into a number of packets transmitted and/or received;
releasing the channel setting; and
displaying the number of packets transmitted and/or received.

2. The method of claim 1, wherein extracting a predetermined payload from the transmitted and/or received data is performed in a TCP layer or a UDP layer.

3. The method of claim 1, wherein the payload comprises a TCP layer or a UDP layer.

4. The method of claim 1, wherein converting the size of the extracted payload into a number of packets transmitted and/or received comprises dividing the stored size of the extracted payload by a predetermined number of bytes corresponding to one packet.

5. The method of claim 1, wherein the size of the extracted payload is measured in bytes.

6. The method of claim 1 further comprising:
setting a state value of a packet amount measuring flag to ‘enable’ when the communication channel is set; and
setting the state value of a packet amount measuring flag to ‘disable’ when the communication channel is released.

7. The method of claim 6, wherein the number of packets displayed comprises the cumulative number of packets transmitted and/or received while the measuring flag is in the ‘enable’ state.

8. The method of claim 1, further comprising calculating a charge amount based on the number of packets transmitted and/or received and displaying the charge amount to the user.

9. The method of claim 8, further comprising alerting the user if a calculated charge amount exceeds a predetermined value.

10. The method of claim 1, wherein the mobile communication device comprises a handset.

11. The method of claim 1, wherein the mobile communication device comprises a Personal Data Assistant (PDA).

12. The method of claim 1, wherein the mobile communication device comprises a personal computer (PC).

13. A method for measuring a number of service packets transmitted and/or received by a mobile communication device comprising:
setting a communication network; setting a channel, accessing a server, and transmitting data and/or receiving data;
extracting a predetermined payload from the transmitted and/or received data;
storing a size of the extracted payload;
converting the size of the extracted payload into a number of packets transmitted and/or received;
outputting the number of packets transmitted and/or received to a display unit; and
performing the processes of extracting, storing, converting, and outputting until the channel setting is released.

14. The method of claim 13, wherein extracting a predetermined payload from the transmitted and/or received data is performed in a TCP layer or a UDP layer.

15. The method of claim 13, wherein the payload comprises a TCP layer or a UDP layer.

16. The method of claim 13, wherein converting the size of the extracted payload into a number of packets transmitted and/or received comprises dividing the stored size of the extracted payload by a predetermined number of bytes corresponding to one packet.

17. The method of claim 13, wherein the size of the extracted payload is measured in bytes.

18. The method of claim 13, further comprising:
setting a state value of a packet amount measuring flag to ‘enable’ when the communication channel is set; and
setting the state value of a packet amount measuring flag to ‘disable’ when the communication channel is released.

19. The method of claim 13, further comprising calculating a charge amount based on the number of packets transmitted and/or received and displaying the charge amount to the user.

20. The method of claim 19, further comprising alerting the user if a calculated charge amount exceeds a predetermined value.

21. The method of claim 13, wherein the mobile communication device comprises a handset.

22. The method of claim 13, wherein the mobile communication device comprises a Personal Data Assistant (PDA).

23. The method of claim 13, wherein the mobile communication device comprises a personal computer (PC).

24. The method of claim 13, wherein outputting the number of packets to a display unit is done substantially continuously.

25. A method for providing information regarding a number of packets exchanged by a communication device, comprising:
exchanging data;
extracting a predetermined payload from the exchanged data;
calculating a number of packets exchanged from the predetermined payload; and
providing information regarding the number of packets exchanged by the communication device via an output device of the communication device.

26. The method of claim 25, further comprising:
establishing a channel setting prior to exchanging data; and
releasing the channel setting prior to providing information regarding the number of packets exchanged by the communication device.

27. The method of claim 26, further comprising:
setting a state value of a packet amount measuring flag to ‘enable’ when the communication channel is set; and
setting a state value of a packet amount measuring flag to ‘disable’ when the communication channel is released.

28. The method of claim 27, wherein the number of packets output to the user via a display device of the mobile communication device comprises a cumulative number of packets transmitted and/or received while the measuring flag is in the ‘enable’ state.

29. The method of claim 25, further comprising:
establishing a channel setting prior to exchanging data; and
continuously performing the processes of extracting, calculating, and providing until the channel setting is released.

30. The method of claim 29, further comprising:
setting a state value of a packet amount measuring flag to ‘enable’ when the communication channel is set; and
setting a state value of a packet amount measuring flag to ‘disable’ when the communication channel is released.

31. The method of claim 30, wherein the number of packets output to the user via a display device of the mobile communication device comprises a cumulative number of packets transmitted and/or received while the measuring flag is in the ‘enable’ state.

32. The method of claim 25, wherein the mobile communication device comprises a handset.

33. The method of claim 25, wherein the mobile communication device comprises a Personal Data Assistant (PDA).

34. The method of claim 25, wherein the mobile communication device comprises a personal computer (PC).

35. The method of claim 25, wherein a size of the extracted payload is measured in bytes, and wherein the number of packets transmitted and/or received is calculated based on the size of the extracted payload and a predetermined packet size.

36. The method of claim 35, wherein calculating the number of packets transmitted and/or received by the mobile communication device comprises dividing the size of the extracted payload by the predetermined number of bytes corresponding to one packet.

37. The method of claim 25, wherein extracting a predetermined payload from the transmitted and/or received data is performed in a TCP layer or a UDP layer.

38. The method of claim 25, further comprising calculating a charge amount based on the number of packets transmitted and/or received and providing the charge amount to a user via an output device of the communication device.

39. The method of claim 38, further comprising alerting the user if a calculated charge amount exceeds a predetermined value.
